(19) United States
(12) Patent Application Publication
(10) Pub. No.: US 2024/0070519 A1
(43) Pub. Date: Feb. 29, 2024

(54) ONLINE FAIRNESS MONITORING IN DYNAMIC ENVIRONMENT

(71) Applicant: INTERNATIONAL BUSINESS MACHINES CORPORATION, Armonk, NY (US)

(72) Inventors: Manish Kesarwani, Bengaluru (IN); Pranay Kumar Lohia, Bhagalpur (IN); Ramasuri Narayanam, Andhra Pradesh (IN); Rakesh Rameshrao Pimplikar, Bangalore (IN); Sameep Mehta, Bangalore (IN)

(21) Appl. No.: 17/822,535

(22) Filed: Aug. 26, 2022

(51) Int. Cl. G06N 20/00; G06N 7/00

(52) U.S. Cl. CPC G06N 20/00; G06N 7/005

(57) ABSTRACT

A method, computer program, and computer system are provided for online fairness monitoring. A dataset having one or more entries with one or more protected attributes and data corresponding to a trained machine learning model is received. An entry having a maximum reward is selected based on a reward probability associated with the entry. A determination is made as to whether bias has developed in the trained machine learning model toward one or more of the one or more protected attributes based on a change to the reward probability or a distribution of reward probabilities exceeding a threshold value.

### FIELD

This disclosure relates generally to field of machine learning, and more particularly to dynamic debiasing of AI models.

### BACKGROUND

Over time, AI models have been increasingly used to make sensitive decisions like money lending or visa approvals. Accordingly, there has been increased focus on ensuring that the deployed models are making fair decisions.

### SUMMARY

Embodiments relate to a method, system, and computer readable medium for online fairness monitoring. According to one aspect, a method for online fairness monitoring is provided. The method may include receiving a dataset having one or more entries with one or more protected attributes and data corresponding to a trained machine learning model. An entry having a maximum reward is selected based on a reward probability associated with the entry. A determination is made as to whether bias has developed in the trained machine learning model toward one or more of the one or more protected attributes based on a change to the reward probability or a distribution of reward probabilities exceeding a threshold value.

According to another aspect, a computer system for online fairness monitoring is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include receiving a dataset having one or more entries with one or more protected attributes and data corresponding to a trained machine learning model. An entry having a maximum reward is selected based on a reward probability associated with the entry. A determination is made as to whether bias has developed in the trained machine learning model toward one or more of the one or more protected attributes based on a change to the reward probability or a distribution of reward probabilities exceeding a threshold value.

According to yet another aspect, a computer readable medium for online fairness monitoring is provided. The computer readable medium may include one or more computer-readable storage devices and program instructions stored on at least one of the one or more tangible storage devices, the program instructions executable by a processor. The program instructions are executable by a processor for performing a method that may accordingly include receiving a dataset having one or more entries with one or more protected attributes and data corresponding to a trained machine learning model. An entry having a maximum reward is selected based on a reward probability associated with the entry. A determination is made as to whether bias has developed in the trained machine learning model toward one or more of the one or more protected attributes based on a change to the reward probability or a distribution of reward probabilities exceeding a threshold value.

### BRIEF DESCRIPTION OF THE DRAWINGS

These and other objects, features and advantages will become apparent from the following detailed description of illustrative embodiments, which is to be read in connection with the accompanying drawings. The various features of the drawings are not to scale as the illustrations are for clarity in facilitating the understanding of one skilled in the art in conjunction with the detailed description. In the drawings:

FIG. 1 illustrates a networked computer environment according to at least one embodiment;

FIG. 2 is a block diagram of a system for online fairness monitoring, according to at least one embodiment;

FIG. 3 is an operational flowchart illustrating the steps carried out by a program that dynamically monitors for and corrects bias in a machine learning environment, according to at least one embodiment;

FIG. 4 is a block diagram of internal and external components of computers and servers depicted in FIG. 1 according to at least one embodiment;

FIG. 5 is a block diagram of an illustrative cloud computing environment including the computer system depicted in FIG. 1, according to at least one embodiment; and

FIG. 6 is a block diagram of functional layers of the illustrative cloud computing environment of FIG. 5, according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

Embodiments relate generally to the field of machine learning, and more particularly to dynamic debiasing of AI models. The following described exemplary embodiments provide a system, method, and computer program to, among other things, monitor machine learning environments for fairness. Therefore, some embodiments have the capacity to improve the field of computing by allowing for dynamic debiasing of AI models as the data used by the model evolves over time.

As previously described, AI models have been increasingly used to make sensitive decisions like money lending or visa approvals. Accordingly, there has been increased focus on ensuring that the deployed models are making fair decisions. The fairness guarantees provided by existing solutions is static since the fairness of the models is only measured at the model creation time and the underlying data distribution is assumed to be fixed. However, in real-world scenarios, the data distribution is often dynamic and evolves over time. This may either be due to updates in the data triggered by decisions made by the model, or new data addition or deletion of old or existing data.

For example, in a simplified version of a money lending scenario, an applicant is granted a loan based on his/her credit score. Whether the user either repays the loan or defaults on the loan affects the original credit score, which directly affects the future lending opportunities. A default event not only diminishes profit for the bank, but it also worsens the financial situation of the borrower as reflected in a subsequent decline in credit score. A successful lending outcome leads to profit for the bank and also to an increase in credit score for the borrower. In the long term, since the model is fixed but the data is evolving, the model may become biased towards a particular group and hence this needs to be monitored and fixed.

It may be advantageous, therefore, to continuously monitor the fairness of a deployed AI model in a dynamic environment where the underlying data distribution is changing over time and to trigger remediation measures if bias is detected. This may be done by detecting whether a deployed AI model that was initially certified for making fair decisions has become biased due to fair decisions made by the model over time and due to the dynamic data distribution changes. The same solution can be used if the data distribution changes due to addition or removal of data.

Dynamic fairness monitoring may be categorized as multi-armed bandit problem or an adversarial bandit problem. In the multi-armed bandit problem, a player must choose which of the K game machines to play. At each time step, the player plays one of the machines and receives a reward or payoff. The reward distribution is assumed to be fixed over time, and the player's purpose is to maximize the received return based on the sum of the rewards the player receives over a sequence of pulls. In this model, each play is assumed to deliver rewards that are independently drawn from a fixed and unknown distribution. As reward distributions differ from machine to machine, the goal is to find the machine with the highest expected payoff as early as possible, and then to keep playing using that best machine. The problem is a paradigmatic example of the trade-off between exploration and exploitation. In the adversarial bandit problem, a variant of the above bandit problem is considered in which no statistical assumptions are made about the generation of rewards.

In the system, method and computer program described herein, rewards are a deterministic function of the credit score. Thus, the distribution of credit score of each group may be considered as the reward distribution. Since the credit score of applicants evolves over time, reward distribution also changes. It may be assumed that there exists a function that provides the expected change in the score for a selected individual at a given score. The probability of repaying a loan is a deterministic function of credit score π(C). Since the model is initially fair, it may be assumed that the borrowers are equally likely to be selected as the best arm.

The execution environment in which the adversarial bandit problem instance may be used to select the most likely arm at each time instance may be simulated. When an arm is selected, then an applicant is sampled uniformly with replacement from the pool of applicants of the group corresponding to that arm, and an AI agent chooses to approve or decline the loan. If the applicant defaults, the agent's profit decreases by r₋ and the applicant's C value is decreased to C₋. If the applicant pays back, the agent's profit is increased by r₊ and the applicant's C value is increased to C₊

Aspects are described herein with reference to flowchart illustrations and/or block diagrams of methods, apparatus (systems), and computer readable media according to the various embodiments. It will be understood that each block of the flowchart illustrations and/or block diagrams, and combinations of blocks in the flowchart illustrations and/or block diagrams, can be implemented by computer readable program instructions.

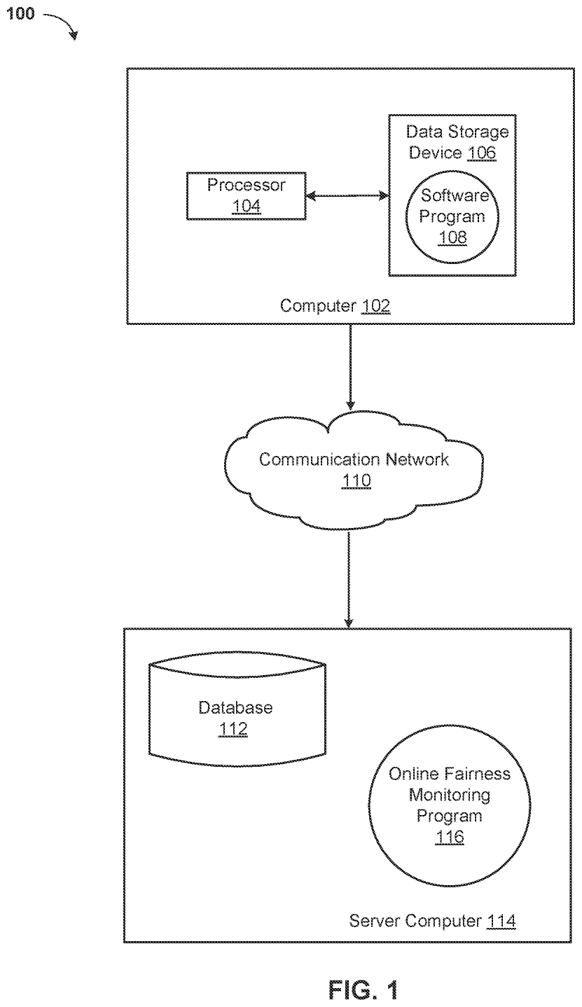

Referring now to FIG. 1, a functional block diagram of a networked computer environment illustrating an online fairness monitoring system 100 (hereinafter “system”) for dynamic debiasing of AI models. It should be appreciated that FIG. 1 provides only an illustration of one implementation and does not imply any limitations with regard to the environments in which different embodiments may be implemented. Many modifications to the depicted environments may be made based on design and implementation requirements.

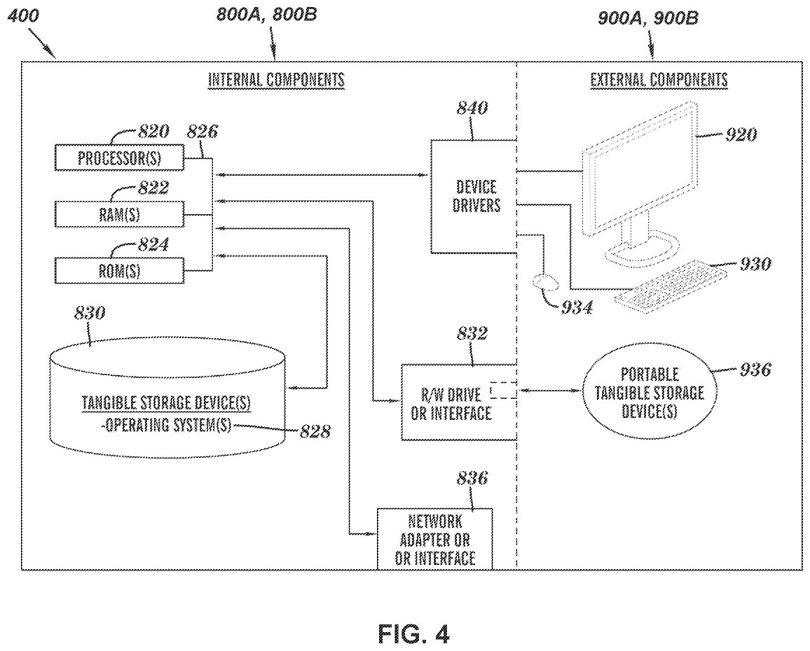

The system 100 may include a computer 102 and a server computer 114. The computer 102 may communicate with the server computer 114 via a communication network 110 (hereinafter “network”). The computer 102 may include a processor 104 and a software program 108 that is stored on a data storage device 106 and is enabled to interface with a user and communicate with the server computer 114. As will be discussed below with reference to FIG. 4 the computer 102 may include internal components 800A and external components 900A, respectively, and the server computer 114 may include internal components 800B and external components 900B, respectively. The computer 102 may be, for example, a mobile device, a telephone, a personal digital assistant, a netbook, a laptop computer, a tablet computer, a desktop computer, or any type of computing devices capable of running a program, accessing a network, and accessing a database.

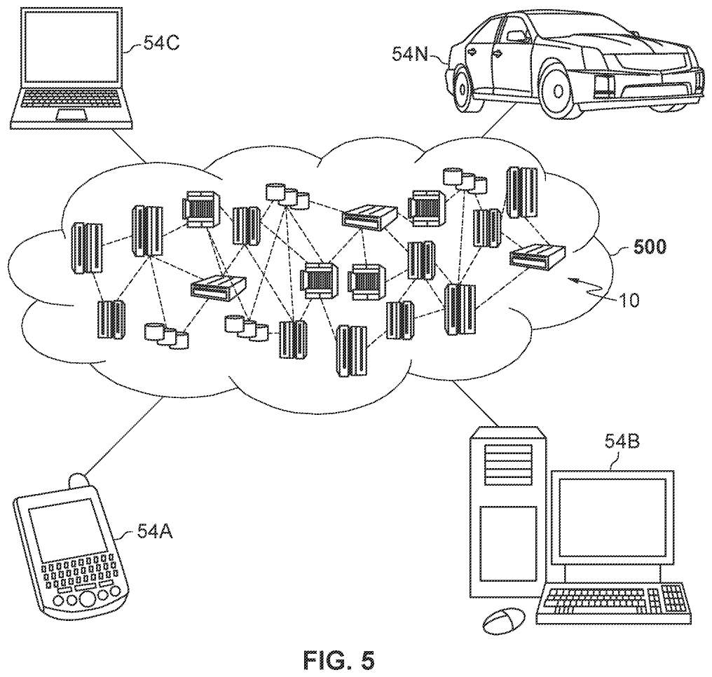

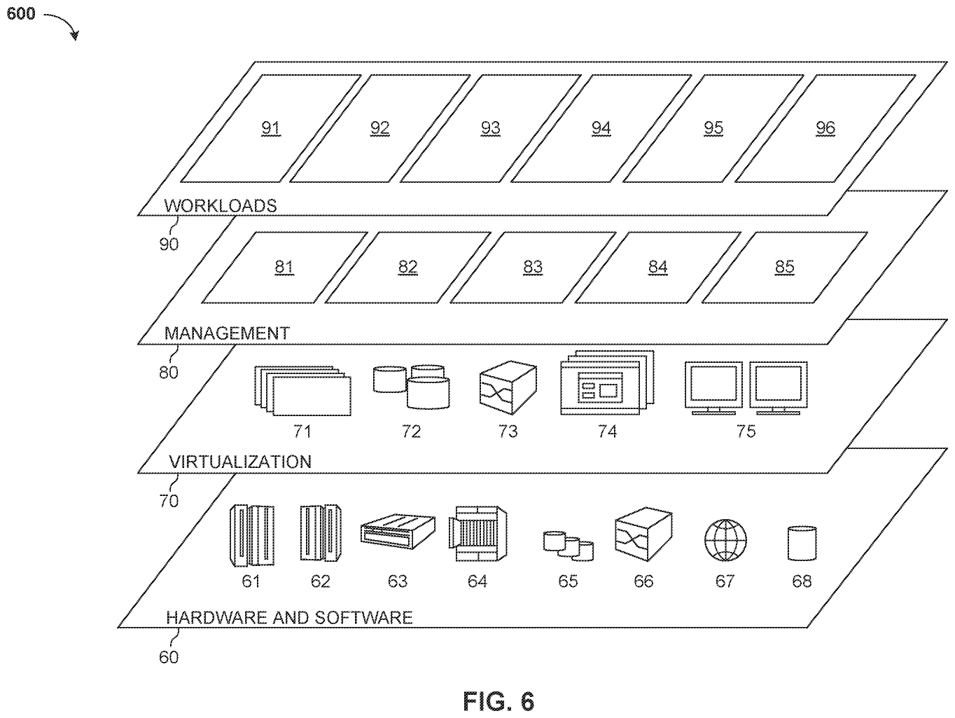

The server computer 114 may also operate in a cloud computing service model, such as Software as a Service (SaaS), Platform as a Service (PaaS), or Infrastructure as a Service (IaaS), as discussed below with respect to FIGS. 5 and 6. The server computer 114 may also be located in a cloud computing deployment model, such as a private cloud, community cloud, public cloud, or hybrid cloud.

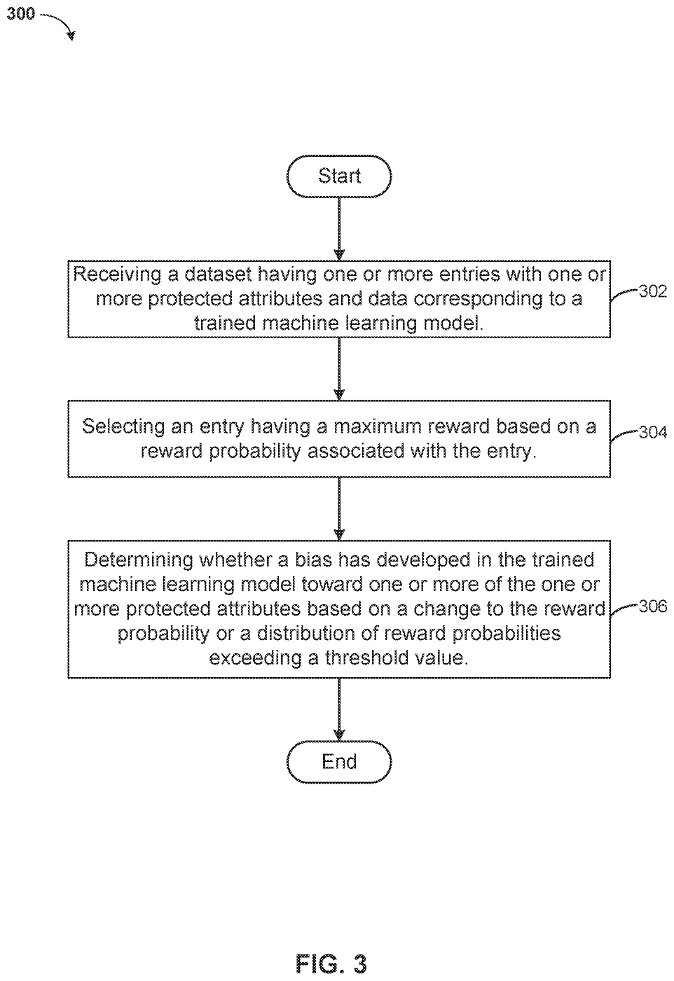

The server computer 114, which may be used for dynamic debiasing of AI models is enabled to run an Online Fairness Monitoring Program 116 (hereinafter “program”) that may interact with a database 112. The Online Fairness Monitoring Program is explained in more detail below with respect to FIG. 3. In one embodiment, the computer 102 may operate as an input device including a user interface while the program 116 may run primarily on server computer 114. In an alternative embodiment, the program 116 may run primarily on one or more computers 102 while the server computer 114 may be used for processing and storage of data used by the program 116. It should be noted that the program 116 may be a standalone program or may be integrated into a larger online fairness monitoring program.

It should be noted, however, that processing for the program 116 may, in some instances be shared amongst the computers 102 and the server computers 114 in any ratio. In another embodiment, the program 116 may operate on more than one computer, server computer, or some combination of computers and server computers, for example, a plurality of computers 102 communicating across the network 110 with a single server computer 114. In another embodiment, for example, the program 116 may operate on a plurality of server computers 114 communicating across the network 110 with a plurality of client computers. Alternatively, the program may operate on a network server communicating across the network with a server and a plurality of client computers.

The network 110 may include wired connections, wireless connections, fiber optic connections, or some combination thereof. In general, the network 110 can be any combination of connections and protocols that will support communications between the computer 102 and the server computer 114. The network 110 may include various types of networks, such as, for example, a local area network (LAN), a wide area network (WAN) such as the Internet, a telecommunication network such as the Public Switched Telephone Network (PSTN), a wireless network, a public switched network, a satellite network, a cellular network (e.g., a fifth generation (5G) network, a long-term evolution (LTE) network, a third generation (3G) network, a code division multiple access (CDMA) network, etc.), a public land mobile network (PLMN), a private network, an ad hoc network, an intranet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of system 100 may perform one or more functions described as being performed by another set of devices of system 100.

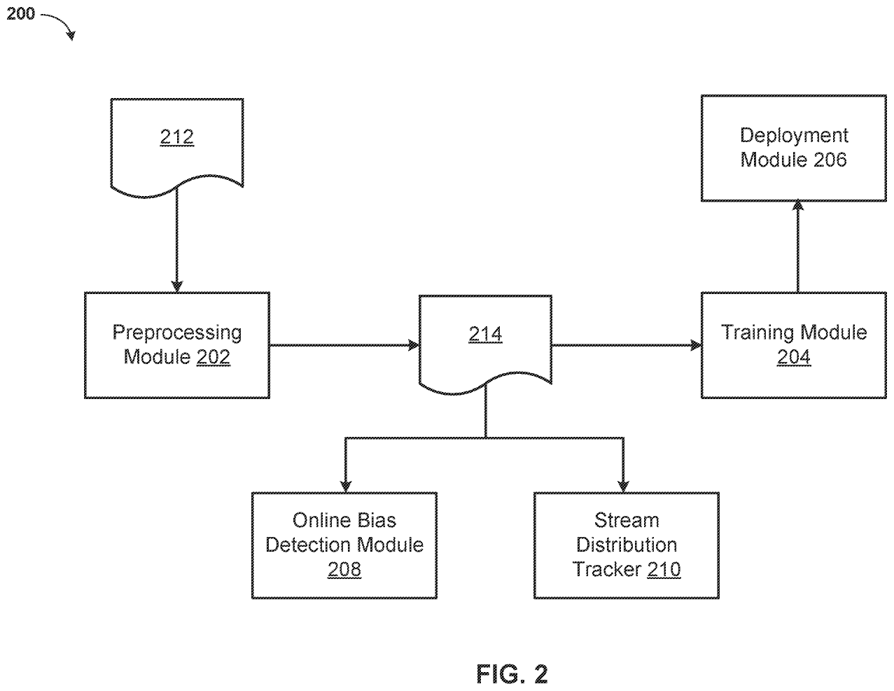

Referring now to FIG. 2, a fairness monitoring system 200 is depicted according to one or more embodiments. The fairness monitoring system 200 may include, among other things, a preprocessing module 202, a training module 204, a deployment module 206, a online bias detection module 208, and a stream distribution tracker 210.

The preprocessing module 202 may receive data 212 that may include, among other things, an exploration parameter γ in the range (0,1], threshold parameters received through user input, a bias tolerance threshold δ, and a distribution tolerance threshold ∈. The preprocessing module 202 may debias the initial data in order to create data 214 that is initially fair. Since the AI model is fair, the initial weight of each category may be set equal to 1, as wᵢ (1)=1 for i=1, . . . , K.

The training module 204 may take one pass over the data 214 to learn the initial distribution of values for each category. The training module 204 may take the data samples of each category separately and may learn the distributions for each category independently. For example, the initial reference distribution be denoted as D₁, D₂, . . . , D_{K}. The deployment module 206 may deploy the fair AI model for use.

In each iteration of the simulation, the online bias detection module 208 may update the distribution and detect changes. This can be done using Distribution-Free One-Pass Learning or individual comparisons by ranking methods. For each t=1, 2, . . . , the online bias detection module 208 may set:

$${p}_{i} ( t ) = ( 1 - γ ) \frac{{w}_{i} ( t )}{{\sum }_{j = 1}^{K} {w}_{j} ( t )} + \frac{γ}{K} for i = 1 , … , K .$$

### The

$$\frac{{w}_{i} ( t )}{{\sum }_{j = 1}^{K} {w}_{j} ( t )}$$

term may be an exploitation term while the

$$\frac{γ}{K}$$

term may be an exploration term in the context of the adversarial bandit/multi-armed bandit problem.

The online bias detection module 208 may select a value it randomly from the probabilities p₁(t), . . . , p_{K}(t) and may select a sample from the data 214 corresponding to the selected value it. The online bias detection module 208 may make predictions using an AI agent. If the agent choses to selects a first option, such as declining a loan in the case of a money lending scenario, then the online bias detection module 208 does not update the data 214. If the agent chooses a second action, such as approving the loan, then the online bias detection module sets the reward

$${x}_{{i}_{t}} ( t ) = \frac{{C}_{+} - C}{C}$$

with probability π(C) and

$${x}_{{i}_{t}} ( t ) = \frac{{C}_{-} - C}{C}$$

with probability 1−π(C). The online bias detection module 208 may update the distribution D it using an updated parameter such as a credit score (C₊ or C₋). Thus, for j=1, . . . , K, set:

$${x}_{j}^{′} ( t ) = \{ \begin{matrix}{x}_{j} ( t ) / {p}_{j} ( t ) if j = {i}_{t} \\ 0 otherwise\end{matrix}$$

$$and$$

$${w}_{j} ( t + 1 ) = {w}_{j} ( t ) exp ( ( γ \times {x}_{j}^{′} ( t ) ) / K ) .$$

At any point in time, if the deployed AI model is not biased, then the probability of selecting each arms will differ at max by a bias tolerance threshold (δ), i.e., for all i,j in 1, . . . , K will be |pᵢ(t)−pⱼ(t)|≤δ.

If any of the differences is outside the bias tolerance threshold (δ), the fairness monitoring system 200 will choose that most favorable arm to maximize its profit. This situation can be interpreted as the system has developed bias for that particular group over time due to the dynamic evolution of the parameter (i.e., credit score).

At any point, if the stream distribution tracker 210 identifies a change in distribution above the distribution tolerance threshold (∈), the stream distribution tracker could also raise warnings for potential bias in the system. This may allow for quantification of the degree of change the model has suffered and may trigger remediation measures if the threshold bound is violated.

Referring now to FIG. 3, an operational flowchart illustrating the steps of a method 300 carried out by a program that dynamically debiases AI models is depicted. The method 300 may be described with the aid of the exemplary embodiments of FIGS. 1 and 2.

At 302, the method 300 may include receiving a dataset having one or more entries with one or more protected attributes and data corresponding to a trained machine learning model. For example, the entries in the dataset may correspond to one or more borrowers and the reward probability corresponds to a credit score associated with each of the one or more borrowers. Thus, it may be determined whether bias exists toward a protected attribute based on the distribution of reward probabilities exceeding a threshold value by determining a distribution of credit scores associated with each of the borrowers, updating the distribution based on a prediction of the machine learning model and a repayment probability associated with each of the borrowers, and detecting whether the updated distribution crosses a distribution tolerance threshold. The credit score may be updated based on a repayment probability. In operation, the preprocessing module 202 (FIG. 2) may receive data 212 (FIG. 2) and may output data 214 (FIG. 2).

At 304, the method 300 may include selecting an entry having a maximum reward based on a reward probability associated with the entry. For example, the reward probability may correspond to a repayment probability in the case of lending. In operation, the training module 204 (FIG. 2) may select an entry from the data 214 to identify an entry giving a maximum reward.

At 306, the method 300 may include determining whether bias has developed in the trained machine learning model toward one or more of the one or more protected attributes based on a change to the reward probability or a distribution of reward probabilities exceeding a threshold value. A sample associated with an entry may be selected, and one or more probability values may be updated based on observed rewards associated with the selected sample. Based on comparing the updated probability values to a bias tolerance threshold value, a determination may be made as to whether the machine learning model exhibits bias toward the protected attribute. The bias determination may be made continuously because bias may develop due to changes in the probability distribution of the data caused due to the prediction made by the model without external factors affecting the data. In operation, the online bias detection module 208 (FIG. 2) and the stream distribution tracker 210 (FIG. 2) may detect bias in the model and may alert a user as to the detected bias or remediate the bias.

It may be appreciated that FIG. 3 provides only an illustration of one implementation and does not imply any limitations with regard to how different embodiments may be implemented. Many modifications to the depicted environments may be made based on design and implementation requirements.

FIG. 4 is a block diagram 400 of internal and external components of computers depicted in FIG. 1 in accordance with an illustrative embodiment. It should be appreciated that FIG. 4 provides only an illustration of one implementation and does not imply any limitations with regard to the environments in which different embodiments may be implemented. Many modifications to the depicted environments may be made based on design and implementation requirements.

Computer 102 (FIG. 1) and server computer 114 (FIG. 1) may include respective sets of internal components 800A,B and external components 900A,B illustrated in FIG. 5. Each of the sets of internal components 800 include one or more processors 820, one or more computer-readable RAMs 822 and one or more computer-readable ROMs 824 on one or more buses 826, one or more operating systems 828, and one or more computer-readable tangible storage devices 830.

Processor 820 is implemented in hardware, firmware, or a combination of hardware and software. Processor 820 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 820 includes one or more processors capable of being programmed to perform a function. The one or more buses 826 include a component that permits communication among the internal components 800A,B.

The one or more operating systems 828, the software program 108 (FIG. 1) and the Online Fairness Monitoring Program 116 (FIG. 1) on server computer 114 (FIG. 1) are stored on one or more of the respective computer-readable tangible storage devices 830 for execution by one or more of the respective processors 820 via one or more of the respective RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory, an optical disk, a magneto-optic disk, a solid-state disk, a compact disc (CD), a digital versatile disc (DVD), a floppy disk, a magnetic tape, and/or another type of non-transitory computer-readable tangible storage device that can store a computer program and digital information.

Each set of internal components 800A,B also includes a RAY drive or interface 832 to read from and write to one or more portable computer-readable tangible storage devices 936 such as a CD-ROM, DVD, memory stick, magnetic tape, magnetic disk, optical disk or semiconductor storage device. A software program, such as the software program 108 (FIG. 1) and the Online Fairness Monitoring Program 116 (FIG. 1) can be stored on one or more of the respective portable computer-readable tangible storage devices 936, read via the respective RAY drive or interface 832 and loaded into the respective computer-readable tangible storage device 830.

Each set of internal components 800A,B also includes network adapters or interfaces 836 such as a TCP/IP adapter cards; wireless Wi-Fi interface cards; or 3G, 4G, or 5G wireless interface cards or other wired or wireless communication links. The software program 108 (FIG. 1) and the Online Fairness Monitoring Program 116 (FIG. 1) on the server computer 114 (FIG. 1) can be downloaded to the computer 102 (FIG. 1) and server computer 114 from an external computer via a network (for example, the Internet, a local area network or other, wide area network) and respective network adapters or interfaces 836. From the network adapters or interfaces 836, the software program 108 and the Online Fairness Monitoring Program 116 on the server computer 114 are loaded into the respective computer-readable tangible storage device 830. The network may comprise copper wires, optical fibers, wireless transmission, routers, firewalls, switches, gateway computers and/or edge servers.

Each of the sets of external components 900A,B can include a computer display monitor 920, a keyboard 930, and a computer mouse 934. External components 900A,B can also include touch screens, virtual keyboards, touch pads, pointing devices, and other human interface devices. Each of the sets of internal components 800A,B also includes device drivers 840 to interface to computer display monitor 920, keyboard 930 and computer mouse 934. The device drivers 840, R/W drive or interface 832 and network adapter or interface 836 comprise hardware and software (stored in computer-readable tangible storage device 830 and/or ROM 824).

It is understood in advance that although this disclosure includes a detailed description on cloud computing, implementation of the teachings recited herein are not limited to a cloud computing environment. Rather, some embodiments are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring to FIG. 5, illustrative cloud computing environment 500 is depicted. As shown, cloud computing environment 500 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 54A-N shown in FIG. 5 are intended to be illustrative only and that cloud computing nodes 10 and cloud computing environment 500 can communicate with any type of computerized device over any type of network and/or network addressable connection (e.g., using a web browser).

Referring to FIG. 6, a set of functional abstraction layers 600 provided by cloud computing environment 500 (FIG. 5) is shown. It should be understood in advance that the components, layers, and functions shown in FIG. 6 are intended to be illustrative only and embodiments are not limited thereto. As depicted, the following layers and corresponding functions are provided:

Hardware and software layer 60 includes hardware and software components. Examples of hardware components include mainframes 61, RISC (Reduced Instruction Set Computer) architecture based servers 62, servers 63, blade servers 64, storage devices 65, and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91, software development and lifecycle management 92, virtual classroom education delivery 93, data analytics processing 94, transaction processing 95, and Online Fairness Monitoring 96. Online Fairness Monitoring 96 may dynamically debias AI models as the data used by the AI models evolves over time.

Some embodiments may relate to a system, a method, and/or a computer readable medium at any possible technical detail level of integration. The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The descriptions of the various aspects and embodiments have been presented for purposes of illustration but are not intended to be exhaustive or limited to the embodiments disclosed. Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of online fairness monitoring in a machine learning model, executable by a processor, comprising:
receiving a dataset having one or more entries with one or more protected attributes and data corresponding to a trained machine learning model;
selecting an entry having a maximum reward based on a reward probability associated with the entry; and
determining whether bias has developed in the trained machine learning model toward one or more of the one or more protected attributes based on a change to the reward probability or a distribution of reward probabilities exceeding a threshold value.

2. The method of claim 1, wherein determining whether bias exists toward a protected attribute based on the reward probability exceeding a threshold value comprises:
selecting a sample associated with an entry;
updating one or more probability values based on observed rewards associated with the selected sample; and
determining, based comparing the updated probability values to a bias tolerance threshold value, whether the machine learning model exhibits bias toward the protected attribute.

3. The method of claim 1, wherein the entries in the dataset correspond to one or more borrowers and the reward probability corresponds to a credit score associated with each of the one or more borrowers.

4. The method of claim 3, wherein determining whether bias exists toward a protected attribute based on the distribution of reward probabilities exceeding a threshold value comprises:
determine a distribution of credit scores associated with one or more groups of the borrowers having a common attribute;
updating the distribution based on a prediction of the machine learning model and a repayment probability associated with each group of the borrowers;
detecting whether the updated distribution crosses a distribution tolerance threshold; and
updating the credit score of the borrowers based on the repayment probability.

5. The method of claim 1, wherein determining whether bias has developed in the trained machine learning model occurs continuously.

6. The method of claim 1, further comprising notifying a user of bias within the machine learning model.

7. The method of claim 1, further comprising remediating the bias within the machine learning model.

8. A computer system for online fairness monitoring, the computer system comprising:
one or more computer-readable non-transitory storage media configured to store computer program code; and
one or more computer processors configured to access said computer program code and operate as instructed by said computer program code, said computer program code including:
receiving code configured to cause the one or more computer processors to receive a dataset having one or more entries with one or more protected attributes and data corresponding to a trained machine learning model;
selecting code configured to cause the one or more computer processors to select an entry having a maximum reward based on a reward probability associated with the entry; and
determining code configured to cause the one or more computer processors to determine whether bias has developed in the trained machine learning model toward one or more of the one or more protected attributes based on a change to the reward probability or a distribution of reward probabilities exceeding a threshold value.

9. The computer system of claim 8, wherein the determining code to determine whether bias exists toward a protected attribute based on the reward probability exceeding a threshold value comprises:
selecting code configured to cause the one or more computer processors to select a sample associated with an entry;
updating code configured to cause the one or more computer processors to update one or more probability values based on observed rewards associated with the selected sample; and
determining code configured to cause the one or more computer processors to determine, based comparing the updated probability values to a bias tolerance threshold value, whether the machine learning model exhibits bias toward the protected attribute.

10. The computer system of claim 8, wherein the entries in the dataset correspond to one or more borrowers and the reward probability corresponds to a credit score associated with each of the one or more borrowers.

11. The computer system of claim 10, wherein the determining code to determine whether bias exists toward a protected attribute based on the distribution of reward probabilities exceeding a threshold value comprises:
determining code configured to cause the one or more computer processors to determine a distribution of credit scores associated with one or more groups of the borrowers having a common attribute;
updating code configured to cause the one or more computer processors to update the distribution based on a prediction of the machine learning model and a repayment probability associated with each group of the borrowers;
detecting code configured to cause the one or more computer processors to detect whether the updated distribution crosses a distribution tolerance threshold; and
updating code configured to cause the one or more computer processors to update the credit score of the borrowers based on the repayment probability.

12. The computer system of claim 8, wherein determining whether bias has developed in the trained machine learning model occurs continuously.

13. The computer system of claim 8, further comprising notifying code configured to cause the one or more computer processors to notify a user of bias within the machine learning model.

14. The computer system of claim 8, further comprising remediating code configured to cause the one or more computer processors to remediate the bias within the machine learning model.

15. A non-transitory computer readable medium having stored thereon a computer program for online fairness monitoring, the computer program configured to cause one or more computer processors to:
receive a dataset having one or more entries with one or more protected attributes and data corresponding to a trained machine learning model;
select an entry having a maximum reward based on a reward probability associated with the entry; and
determine whether bias has developed in the trained machine learning model toward one or more of the one or more protected attributes based on a change to the reward probability or a distribution of reward probabilities exceeding a threshold value.

16. The computer readable medium of claim 15, wherein based on determining whether bias exists toward a protected attribute is based on the reward probability exceeding a threshold value, the computer program is configured to cause the one or more computer processors to:
select a sample associated with an entry;
update one or more probability values based on observed rewards associated with the selected sample; and
determine, based comparing the updated probability values to a bias tolerance threshold value, whether the machine learning model exhibits bias toward the protected attribute.

17. The computer readable medium of claim 15, wherein the entries in the dataset correspond to one or more borrowers and the reward probability corresponds to a credit score associated with each of the one or more borrowers.

18. The computer readable medium of claim 10, wherein based on determining whether bias exists toward a protected attribute is based on the distribution of reward probabilities exceeding a threshold value, the computer program is configured to cause the one or more computer processors to:
determine a distribution of credit scores associated with one or more groups of the borrowers having a common attribute;
update the distribution based on a prediction of the machine learning model and a repayment probability associated with each group of the borrowers;
detect whether the updated distribution crosses a distribution tolerance threshold; and
update the credit score of the borrowers based on the repayment probability.

19. The computer readable of claim 15, wherein determining whether bias has developed in the trained machine learning model occurs continuously

20. The computer readable medium of claim 15, wherein the computer program is further configured to cause the one or more computer processors to notify a user of bias within the machine learning model.
